(19) United States
(12) Patent Application Publication
(10) Pub. No.: US 2016/0192664 A1
(43) Pub. Date: Jul. 7, 2016

(54) COMPOSITION OF WHITE KIDNEY BEAN EXTRACT USED IN BAKED FOOD PROCESSING

(71) Applicant: MING CHEN LEE, TAIPEI CITY (TW)

(72) Inventor: MING CHEN LEE, TAIPEI CITY (TW)

(21) Appl. No.: 14/590,154

(22) Filed: Jan. 6, 2015

(51) Int. Cl. A21D 2/36

(52) U.S. Cl. CPC A21D 2/362

(57) ABSTRACT

The present invention relates to a composition comprising white kidney bean extract Fabenol and trehalose, and optionally water-soluble dietary fiber, for combing with food materials, such as butter, flour and egg to manufacture baked products in the high temperature baking process, for example at 120 to 200° C. The composition of present invention remains the inhibitory activity on α-amylase under the baking condition of high temperature, which will offer a lowered degradation rate of starch in the baked products to make the baked food meeting the taste without increasing burden to consumers.

### BACKGROUND OF THE INVENTION

1. Technical Field of the Invention

The present invention relates to the use of compositions comprising white kidney bean extract in baked food processing. Especially, the present invention relates to a composition comprising white kidney bean extract Fabenol and trehalose, and optionally water-soluble dietary fiber, for combining with food materials, such as butter, flour and egg to manufacture baked products in high temperature baking process.

2. Background

In 1980, some clinical researchers in US have begun to study the blood sugar controlling effects of amylase inhibitors to the patients with diabetes. The results found that amylase inhibitors may help the glycemic control in diabetes patients. In 1987, another research group Sony Stony Brook obtained the same results with similar substances of amylase inhibitor. Also in 1996, the other research group obtained consistent results using starch as material. Therefore, certain commercially available amylase-inhibitor capsules have been used to control blood sugar, even as slimming products for reducing the calorie.

In recent years, biochemists discovered that natural foods such as white kidney bean, wheat and high-starch foods contain amylase blocking ingredients. The phaselarmin in white kidney bean exhibits inhibitory effects on the α-amylase activity for converting starch to sugars. It is known that uncooked white kidney beans are toxic, and the amylase inhibitors in cooked white kidney beans are easily destroyed by heating. Thus, certain special biochemical techniques had been developed to extract the effective components with amylase suppressing activity from white kidney beans, and prepare the components into capsules for administrating to the patient needed for.

However, oral capsules make people feel like taking a medicine, and start to suppress starch decomposition when they reach the duodenum. Thus, people should note the time of taking for achieving the desired amylase inhibitory activity provide by the capsules. It is very inconvenient to eat, and the inhibitory effects will be varied by the eating habits of users. On the other hand, since starch can be digested by the amylase in mouth, the inhibitory effects on amylase by additive amylase inhibitors contained in high-starch foods may be started in the mouth after eating. As a result, the starch degradation will be significantly reduced, and the inhibitory effect lasting in the intestine can reduce the available calorie in such foods, and delay the elevation of blood sugar and reduce the maximum blood glucose level after eating.

Therefore, the present invention adds amylase inhibitors into starch-based foods thereby, maintains the taste and flavor of food and reduces the calorie generated by the starch, which will not cause excessive burden to the eaters. Furthermore, the addition of amylase inhibitor will help and benefit the patients with diabetes and obesity problems by offering diet satisfaction to such patients.

### SUMMARY OF INVENTION

For the purpose described above, the present invention finds that the amylase inhibitory effects of white kidney bean extract Fabenol to reduce the degradation of starch will be protected and maintained under a high temperature baking condition, for example at 120° C. to 200° C. (preferably above 180° C.), when combined with trehalose, or optionally with water-soluble dietary fiber, which may be used to admix with food materials, such as butter, flour and egg to manufacture baked products.

Accordingly, in one aspect, the present invention relates to a composition for adding to a preparation to manufacture baked products, comprising white kidney bean extract Fabenol and trehalose. or optionally water-soluble dietary fiber.

In certain embodiments of the present invention, the white kidney bean extract is Fabenol Max. In an embodiment of the present invention, the water soluble dietary fiber includes a natural water soluble vegetable fiber selected from corn fiber and plantago seed fiber.

In another aspect, the present invention relates to a processing method of baked products, comprising adding the composition comprising white kidney bean extract Fabenol and trehalose, or optionally water-soluble dietary fiber to a food material preparation containing butter, flour and eggs; mixing the composition and the food materials to obtain a mixture; and baking the mixture at a high temperature of 120to 200° C. to manufacture a baked product.

In some embodiments of the present invention, the baking procedure is performed at 180° C. In other embodiments of the present invention, the baked product is a pastry of pineapple cake.

Using the embodiments of the present invention, the processing method comprises the steps of:
adding the composition comprising white kidney bean extract Fabenol and trehalose, or optionally water-soluble dietary fiber to a food material preparation containing flour, butter and egg;
mixing the composition and the food material preparation adequately to obtain a mixed dough; and
shaping and baking the mixed dough at a temperature of 120° C. to 200° C. to manufacture a baked product. The baked product is a pastry of cake, especially a pastry of pineapple cake.

### BRIEF DESCRIPTION OF THE DRAWINGS

No Figures attached

### DETAILED DESCRIPTION OF THE INVENTION

The other characteristics and advantages of the present invention will be further illustrated and described in the following examples. The examples described herein are using for illustrations, not for limitations of the invention.

In the following examples, a pastry of pineapple cake is produced as a preferable exemplary baked product combined with kidney bean extract. The assays for evaluating the amylase inhibitory activity of baked product by determining the degradation rate of starch were conducted in the Department of Food Science of National Ilan University. The procedures of the assays are briefly described as follow.

Extraction of Starch Samples

Food sensory evaluation is conducted by the staff of the company with recording the feelings after eating, including pastry appearance, odor, hardness, taste and the like.

Protective Effects of Water Soluble Dietary Fiber on the Activity of Amylase Inhibitor

According to the information of amylase inhibitor provided from the manufacturer, α-amylase will completely lose its activity at a temperature above 120° C. Therefore, a test is carried out for selecting known water soluble dietary fibers with protective effects on the white kidney bean extract Fabenol Max (an amylase inhibitor) under high temperature baking condition. The formulations of the pastry of pineapple cake with adding various water soluble dietary fibers are listed in Table 1.

TABLE 1
formulations of pastry of pineapple cake

| | Standard | | | | | | | |
|---|---|---|---|---|---|---|---|---|
| | formula | Control | 1(⊚) | 2(♦) | 3() | 4(▪) | 5() | 6(▴) |
| Material | % | % | % | % | % | % | % | % |
| Butter | 50 | 50 | 50 | 50 | 50 | 50 | 50 | 50 |
| Trehalose | 3 | 3 | 3 | 3 | 3 | 3 | 3 | 3 |
| Emulsifier | 1.5 | 1.5 | 1.5 | 1.5 | 1.5 | 1.5 | 1.5 | 1.5 |
| Sugar | 25 | 25 | 25 | 25 | 25 | 25 | 25 | 25 |
| Salt | 0.25 | 0.25 | 0.25 | 0.25 | 0.25 | 0.25 | 0.25 | 0.25 |
| Egg | 25 | 25 | 25 | 25 | 25 | 25 | 25 | 25 |
| Milk powder | 10 | 10 | 10 | 10 | 10 | 10 | 10 | 10 |
| Flour | 100 | 100 | 100 | 100 | 100 | 100 | 100 | 100 |
| β-carotene | 0.15 | 0.15 | 0.15 | 0.15 | 0.15 | 0.15 | 0.15 | 0.15 |
| Fabenol Max | 1 | — | 1 | 1 | 1 | 1 | 1 | 1 |
| Girasole | — | — | 5 | — | — | — | — | — |
| fiber | | | | | | | | |
| Corn fiber | — | — | — | 5 | — | — | — | — |
| Konjac fiber | — | — | — | — | 5 | — | — | — |
| Dextrin fiber | — | — | — | — | — | 5 | — | — |
| Soybean | — | — | — | — | — | — | 5 | — |
| fiber | | | | | | | | |
| Plantago | — | — | — | — | — | — | — | 5 |
| seed fiber | | | | | | | | |
| Sum | — | — | — | — | — | — | — | — |

Heated at 180° C./120° C. for 20 min, turned upside down and then heated for another 10 min

The white kidney bean extract Fabenol Maxis mixed with the materials in the recipe of pastry containing butter, egg, flour, and sugar powder. The water soluble dietary fiber is added to the mixture and mixed adequately to obtain mixed dough. The dough is shaped and baked at 180° C. to obtained the pastry of pineapple cake. The pastry is assayed for the starch degradation rate using the methods of amylase test described above to evaluate the amylase inhibitory activity of the baked product. The results are listed in Table 2.

TABLE 2
Inhibition of starch degradation in the pastries with or without addition
of amylase inhibitor and various water soluble dietary fibers

| | Inhibition of starch |
|---|---|
| Sample | degradation (%) |
| without adding Fabenol Maxis (Control) | 0 |
| Fabenol Maxis | 0 |
| Corn fiber + Fabenol Maxis | 4.7 |
| Konjac fiber + Fabenol Maxis | 0.2 |
| Plantago seed fiber + Fabenol Maxis | 4.7 |
| Soybean fiber + Fabenol Maxis | −5.3 |
| Dextrin fiber + Fabenol Maxis | 2.2 |
| Girasole fiber + Fabenol Maxis | −5.9 |

As shown in Table 2, the baked pastry simply containing white kidney bean extract Fabenol Maxis will lose the amylase inhibitory activity after heating at 180° C. On the other hand, the baked pastry with the addition of water-soluble dietary fiber and amylase inhibitor Fabenol Maxis exhibits the amylase inhibitory activity after baking. It is shown that the water soluble dietary fiber, such as corn fiber, plantago seed fiber and dextrin fiber can protect amylase inhibitor from denaturation under the baking condition of high temperature. Especially, corn fiber and plantago seed fiber confer a better protective effect, with almost 5% inhibition of starch degradation.

According to the results of the sensory evaluation, the baked pastry containing plantago seed fiber turns harder. The baked pastry containing corn fiber taste good (moderate in the hardness), and felt no fuel smell, exhibiting a proper milk flavor. Therefore, corn fiber is used as the water-soluble dietary fiber for adding to the test pastry in the following experiments.

Protective Effects of Trehalose and Water-Soluble Dietary Fiber on the Activity of Amylase Inhibitor

Recipes of pastry of pineapple cake with different amount of trehalose and corn fiber are listed in Table 3, based on 1 unit of weight of white kidney bean extract Fabenol Maxis as reference quantity.

TABLE 3

| | A | B | C |
|---|---|---|---|
| Butter | 50 | 50 | 50 |
| Trehalose | 3 | 3 | — |
| Sugar powder | 25 | 25 | 25 |
| Egg | 25 | 25 | 25 |
| Milk powder | 10 | 10 | 10 |
| Flour | 100 | 100 | 100 |
| Fabenol Maxis | 1 | 1 | 1 |
| Corn fiber | 5 | — | — |

1 to 5 units of weight of trehalose, with or without 1 to 10 units of weight of corn fiber, is mixed with the materials of pastry including butter, egg, flour, and sugar powder to obtain mixed dough. The dough is shaped and baked at 120° C.˜200° C., preferably at 180° C. to obtained the pastry of pineapple cake. The pastry is assayed for the starch degradation rate using the methods of amylase test described above to evaluate the amylase inhibitory activity of the baked product. The results are listed in Table 4.

TABLE 4

| | Inhibition of starch |
|---|---|
| | degradation (%) |
| A: Fabenol Maxis + Trehalose + Corn fiber | 55.7 |
| B: Fabenol Maxis + Trehalose | 46.2 |
| C: Fabenol Maxis | 20.7 |

It is demonstrated by the data showed in above experiments that trehalose improves the amylase inhibitory effect of Fabenol Maxis, with [06.2-20.7)/20.7]*100%=123%. The combination of trehalose and corn fiber can provide more improvement in the amylase inhibitory effect of Fabenol Maxis, with [(55.7-20.7)/20.7]*100%=169%.

In summary, the combination of white kidney bean extract, water-soluble dietary fiber and/or trehalose will effectively protect the inhibitory effects on amylase of the white kidney bean extract from being destroyed under the high baking temperature(above 120° C.). The protective effects will promise the white kidney bean extract to be added in baked food processing as an amylase inhibitor for reducing the starch degradation in foods. The addition of the amylase inhibitor composition of present invention in high-starch foods will help reduce the available calorie in such foods, and cause no excessive burden to the eaters. Furthermore, series of low-calorie healthy foods may be developed for benefiting patients with diabetes and obesity problems according to the disclosure of present invention.

1. A composition for baked food processing at a temperature above 120° C., which comprises 1 unit of weight of white kidney bean extract and 1 to 5 units of weight of trehalose, wherein said trehalose protects an ability of the white kidney bean extract to inhibit conversion of starch to sugars when the baked food is eaten and the baked food is produced at temperatures of 120 to 200° C.

2. The composition of claim 1, which further comprises 1 to 10 units of weight of water-soluble dietary fiber.

3. The composition of claim 2, wherein the water-soluble dietary fiber is water soluble vegetable fiber selected from at least one of corn fiber and plantago seed fiber.

4. A processing method of baked products, which comprises the steps of:
adding a composition which comprises 1 unit of weight of white kidney bean extract and 1 to 5 units of weight of trehalose to a food material preparation containing flour;
mixing the composition and the food material preparation adequately to obtain a mixed dough; and
shaping and baking the mixed dough at a temperature of 120 to 200° C. to manufacture a baked product, and wherein the white kidney bean extract retains an ability to reduce the degradation of starch when the baked products are eaten and the baked products are produced at temperatures of 120 to 200° C.

5. The method of claim 4, wherein the composition further comprises 1 to 10 units of weight of water-soluble dietary fiber.

6. The method of claim 5, wherein the water-soluble dietary fiber is water soluble vegetable fiber selected from at least one of corn fiber and plantago seed fiber.

7. The method of claim 4, wherein the baking procedure is performed at 180° C.

8. The method of claim 4, wherein the food material preparation further contains butter, sugar and eggs.

9. The method of claim 5, wherein the food material preparation further contains butter, sugar and eggs.

10. The method of claim 7, wherein the food material preparation further contains butter, sugar and eggs.

11. The method of claim 8, wherein the baked product is a pastry of pineapple cake.

12. The method of claim 9, wherein the baked product is a pastry of pineapple cake.

13. A baked product containing a composition of white kidney bean extract, which is prepared by mixing the composition which comprises 1 unit of weight of white kidney bean extract and 1 to 5 units of weight of trehalose with a food material preparation comprising flour, and baked at a temperature of 120 to 200° C. after shaping the mixture, and wherein the white kidney bean extract retains an ability to reduce the degradation of starch when the baked product is eaten and the baked product is produced at temperatures of 120 to 200° C.

14. The baked product of claim 13, wherein the composition further comprises 1 to 10 units of weight of water-soluble dietary fiber.

15. The baked product of claim 14, wherein the water-soluble dietary fiber water is soluble vegetable fiber selected from at least one of corn fiber and plantago seed fiber.

16. The baked product of claim 13, wherein the food material preparation further contains butter, sugar and eggs.

17. The baked product of claim 14, wherein the food material preparation further contains butter, sugar and eggs.

18. The baked product of claim 13, the baked product is a pastry of pineapple cake.

19. The baked product of claim 14, the baked product is a pastry of pineapple cake.

20. The baked product of claim 16, the baked product is a pastry of pineapple cake.
